(19) United States
(12) Patent Application Publication
(10) Pub. No.: US 2025/0234369 A1
(43) Pub. Date: Jul. 17, 2025

(54) METHOD AND APPARATUS FOR SUPPORTING ENERGY USAGE IN COMMUNICATION NETWORK

(71) Applicant: SAMSUNG ELECTRONICS CO., LTD., Suwon-si (KR)

(72) Inventors: Tingyu XIN, Staines (GB); David Gutierrez ESTEVEZ, Staines (GB); Erik GUTTMAN, Staines (GB)

(21) Appl. No.: 19/014,063

(22) Filed: Jan. 8, 2025

(30) Foreign Application Priority Data
Jan. 11, 2024 (GB) 2400410.3
Jan. 12, 2024 (GB) 2400460.8
Jan. 22, 2024 (GB) 2400807.0
Feb. 16, 2024 (GB) 2402175.0
Apr. 5, 2024 (GB) 2404866.2
Dec. 16, 2024 (GB) 2418431.9

(51) Int. Cl. H04W 72/52; H04W 24/04; H04W 28/16

(52) U.S. Cl. CPC H04W 72/52; H04W 24/04; H04W 28/16

(57) ABSTRACT

The disclosure relates to a 5G or 6G communication system for supporting a higher data transmission rate. According to an embodiment of the present disclosure, a method performed by an Application Function (AF) for obtaining energy information from an Energy Information Function (EIF) in a communication network is provided. The method may comprise transmitting a subscription request related to the energy information to the EIF, via a Network Exposure Function (NEF); receiving a response for the subscription request from the EIF; and receiving the energy information from the EIF based on the subscription request being authorized by the EIF.

### CROSS-REFERENCE TO RELATED APPLICATIONS

This application is based on and claims priority under 35 U.S.C. § 119 to United Kingdom Patent Application No. 2400410.3 filed on Jan. 11, 2024, United Kingdom Patent Application No. 2400460.8 filed on Jan. 12, 2024, United Kingdom Patent Application No. 2400807.0 filed on Jan. 22, 2024, United Kingdom Patent Application No. 2402175.0 filed on Feb. 16, 2024, United Kingdom Patent Application No. 2404866.2 filed on Apr. 5, 2024, and United Kingdom Patent Application No. 2418431.9 filed on Dec. 16, 2024, in the United Kingdom Intellectual Property Office, the disclosures of which are incorporated by reference herein in their entirety.

### BACKGROUND

### 1. Field

The present disclosure relates to enhancements to subscriptions and policy control for supporting energy efficiency and energy saving in a telecommunication network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Currently, there are more than 110 countries committed to a net zero emissions target by 2050. The Paris Agreement attempts to ensure global temperatures stay within 2C by 2100, but preferably closer to 1.5C. The motivation of reducing energy emissions and increasing the energy efficiency of the telecoms sector is more urgent than before. Also, considering that the price of energy is going up, and the increasing traffic load of telecoms systems, mobile network operators are keen to optimize the costs of ongoing operations/operating expenses (opex). Energy-saving measures in network operations are necessary for New Radio (NR) equipment and other components of telecommunications systems.

### SUMMARY

According to an embodiment of the present disclosure, a method performed by an Application Function (AF) for obtaining energy information from an Energy Information Function (EIF) in a communication network is provided. The method may comprise transmitting a subscription request related to the energy information to the EIF, via a Network Exposure Function (NEF); receiving a response for the subscription request from the EIF; and receiving the energy information from the EIF based on the subscription request being authorized by the EIF.

In case that the subscription request is authorized by the NEF, the subscription request may be delivered by the NEF to the EIF.

The energy information may include energy consumption information.

The energy information may be at least one of: a User Equipment (UE) level, a Protocol Data Unit (PDU) session level, and a Quality of Service (QOS) flow level.

The method may further comprise transmitting a request for resources for a session related to energy saving to the NEF.

If the request for the resources is approved by the PCF, the PCF may inform a Session Management Function (SMF) of the request for managing the session.

The request may comprise an energy saving profile including at least one of a desired energy saving, a consumption level, efficiency, and communication service features that can be adjusted according to a required energy savings level and energy credit.

The method may further comprise transmitting an unsubscription request related to the energy information to the IEF.

According to an embodiment of the present disclosure, an apparatus for an Application Function (AF) for obtaining energy information from an Energy Information Function (EIF) in a communication network is provided. The apparatus may comprise a transceiver; and at least one processor coupled to the transceiver. The at least one processor may be configured to transmit a subscription request related to the energy information to the EIF, via a Network Exposure Function (NEF); receive a response for the subscription request from the EIF; and receive the energy information from the EIF based on the subscription request being authorized by the EIF.

According to an embodiment of the present disclosure, a method performed by an Energy Information Function (EIF) for providing energy information in a communication network is provided. The method may comprise receiving g a subscription request related to the energy information from an Application Function (AF), via a Network Exposure Function (NEF); transmitting a response for the subscription request to the AF; and transmitting the energy information to the AF based on authorizing the subscription request.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a message flow according to an embodiment of the present disclosure;

FIG. 2 illustrates a message flow according to an embodiment of the present disclosure;

FIG. 3 illustrates a message flow according to an embodiment of the present disclosure; and

FIG. 4A and FIG. 4B illustrate a message flow according to an embodiment of the present disclosure.

FIG. 5 illustrates a block diagram of an apparatus for a network entity according to an embodiment of the present disclosure.

### DETAILED DESCRIPTION

Compared to previous generations, the 5G New Radio (NR) offers a significant energy-efficiency improvement in its first release (3GPP Rel-15), i.e., cell activation/deactivation over Xn/X2/F1 interface via coordination between peer eNB/gNBs, sparser RS and SS signals, URLLC, CU/DU architecture and MR-DC, etc. However, based on the GSMA report ‘5G energy efficiencies: Green is the new black’ (https://data.gsmaintelligence.com/api-web/v2/research-file-download?id=54165956&file=241120-5G-energy.pdf) published in 2020, Network opex tends to account for around, e.g., 25% of Verizon's cost base, or 10% of revenue. In addition, over 90% of network costs are spent on energy, consisting mostly of fuel and electricity consumption.

To further reduce energy consumption, and improve the efficiency of the 3GPP system, in releases later than Rel-15, some of the working groups (WGs) in Radio Access Network (RAN), Service and System Aspects (SA), and Core Networks and Terminals (CT) have completed or are developing mechanisms to increase energy saving or energy efficiency. To reduce the energy consumption of the RAN part, in Rel-18, RAN WG started to study and specify the techniques on network energy savings (RAN WID in RP-223540/RP-230566 Sept. 2023), and RAN will further work on network energy saving improvement in Rel-19 (RP-234065) by supporting on-demand SSB SCell operation for UEs in connected mode, on-demand SIB1 for UEs in idle/inactive mode, and adaptation of common signal/channel transmissions.

SA5 started their work on Energy Efficiency of the 5G system in Rel-16. In Rel-17 (TR 28.813-Study on new aspects of Energy Efficiency (EE) for 5G) and Rel-18 (TR 28.913), SA5 extended its scope from RAN only to the whole 5G system. The specified techniques are documented in TS 28.310 ‘Management and orchestration; Energy efficiency of 5G’ and the corresponding KPIs and measurements related to Energy Efficiency (EE) are documented in TS 28.552 ‘Management and orchestration; 5G performance measurements’ and TS 28.554 ‘Management and orchestration; 5G end to end Key Performance Indicators (KPI)’. In Rel-19, SA5 will keep working on energy efficiency and energy saving aspects of 5G networks and services according to the SID approved in SP-231723 in December 2023.

SA1 is currently working on the potential requirements and solutions on Rel-19 Energy Efficiency as a service criteria (acronym: EnergyServ). This topic is due to be 100% completed by TSG 102 (December 2023). The outcome of the study phase is documented in TR 22.882 ‘Study on Energy Efficiency as service criteria’. And some of the specified SA1 stage 1 requirements, e.g., the maximum energy credit, might be down streamed to SA2 for further stage 2 work.

In the previous releases of NR (earlier than Rel-19), the studies concentrated more on how to satisfy user experience and try to achieve energy efficiency at the same time. The use cases and solutions basically concern enhancements within the 3GPP network. For example, requirements for energy efficiency have been introduced by SA1 to clause 6.15 of TS 22.261 as a fundamental 5G system requirement. However, those requirements focused more on the optimization of UEs battery life based on network configuration and control, including the UEs using small rechargeable and single coin cell batteries. But the verticals (diverse industry sectors' service providers) and customers have no approach to enhance or improve the energy efficiency for the whole system.

SA1 has completed a study on energy efficiency as a service in Rel-19 (TR 22.882), which enables the users to select energy efficiency criteria based on request and some of the network performance parameters as needed. Therefore, in some scenarios, e.g., a satellite and terrestrial convenience scenario, the users or operators could choose/request the best way in satisfying both user experience and energy efficiency. At the same time, the network could also deploy the more efficient strategies, i.e., energy-efficient network resource allocation and scheduling.

The SA1 work on Energy Efficiency as a service criteria mainly focuses on:
Defining and supporting energy efficiency criteria as part of the communication service to user and the application services.
Providing information exposure on systematic energy consumption or level of energy efficiency to vertical customers.

The conclusions of this study have been captured in the 5G system requirements specification, TS 22.261. These requirements might be addressed by SA2, the system architecture group. SA2 is studying potential solutions to accomplish or satisfy the corresponding SA1 requirements. The consolidated conclusions include, but are not limited to, the following (in clause 6 of TR 22.882 and clause 6.15a of TS 22.261):
Subject to operator's policy, the 5G system shall support subscription policies and means to enforce the policy that define a maximum energy consumption rate for services without QoS criteria;
The 5G network shall support a means to define maximum energy consumption rate with specific granularities (which include subscriber granularity, network slice granularity).
Subject to operator's policy, the 5G system shall support subscription policies that define a maximum energy credit limit for services. The maximum energy credit limit could be used to control the services.
Charging related requirements, i.e., subject to operator's policy, the 5G system shall support a means to associate energy consumption with charging information based on subscription policies.
The 5G system shall support different energy states of network elements and network functions and dynamic switching between different energy states.
For monitoring and measurement related to energy efficiency purposes, the 5G network shall support energy consumption monitoring at per network slice and per subscriber granularity, the 5G system shall be able to acquire energy consumption information of the network functions serving this 3rd party, the 5G system shall be able to acquire the ratio of renewable energy used to provide dedicated communication service to this 3rd party on a periodic basis, the 5G system shall be able to acquire the energy efficiency information (e.g., including the estimated carbon emissions) related to a subscriber based on the subscriber's data volume over a specific period of time, the operator's network energy consumption, and the carbon intensity of operator's network.

To improve the energy saving/efficiency and reduce the operation expense of the NR system, in Rel-15 and later releases, RAN3 introduced energy saving for intra-and inter-system, as described in clause 15.4 of TS 38.300. This function allows the deployment of capacity boosters which provides extra capability on top of the basic coverage. Different from the cell that provides basic coverage, the capacity booster cells could be turned on and off by the NR-RAN node or the O&M autonomously, i.e., based on the load of the cell. The activation status or request of the capacity booster cell will be interacted over Xn interface between the corresponding NG-RAN nodes. The O&M-involved energy saving was specified by SA5 and documented in clause 5.1.3.3 of TS 28.310.

In Rel-18, considering the significant operational cost in the radio part, RAN approved the topic-‘Network energy savings for NR’ in order to optimize the energy consumption and energy efficiency of the radio part. The objectives of RAN WGs include, but are not limited to, the following:
Specify SSB-less SCell operation for inter-band CA for FR1 and co-located cells.
Specify enhancement on cell DTX/DRX mechanism including the alignment of cell DTX/DRX and UE DRX in RRC_CONNECTED mode, and inter-node information exchange on cell DTX/DRX.
Improve energy efficiency or reduce energy consumption via spatial and power domains optimization, i.e., enhancements on CSI and beam management related procedures.
Specify mechanism(s) to prevent legacy UEs camping on cells adopting the Rel-18 NES techniques, if necessary.
Specify CHO procedure enhancement(s) in case source/target cell is in NES mode.
Specify inter-node beam activation and enhancements on restricting paging in a limited area.
Specify the corresponding RRM/RF core requirements, if necessary, for the above features.

For the above RAN works, 5GC is not involved in either the decision making on energy saving and energy efficiency enhancement, nor the capacity booster cell activation and deactivation, nor configuration in the current standards.

3GPP SA5 started the work on ‘Energy efficiency of 5G’ since Rel-16. In Rel-16, SA5 focused on the Energy Efficiency (EE) and Energy Saving(ES) of mobile networks. In Rel-17, the SA5 extended the scope from RAN part only to the whole 5G system. EE Key Performance Indicators (KPIs) have been defined for the 5G core network, network slices, etc. SA5 work focuses on OA&M, i.e., defining mechanisms to collect measurements from the 5G Network Functions via OA&M standardized APIs.

Performance of network slices has been defined per type of network slice, namely for enhanced Mobile Broadband (eMBB), Ultra-Reliable and Low Latency Communication (URLLC) and massive Internet of Things (MIOT), whereas user plane traffic volumes have been considered to define the performance of the 5GC. How to measure the energy consumption (EC) of Physical Network Functions (PNF) has been defined by ETSI EE. However, how to measure the EC of Virtualized Network Functions (VNF) was blank. In Rel-17, SA5 has defined a method to estimate it, based on the estimated energy consumption of the underlying virtual compute resource instance(s), i.e., Virtual Machine(s) (VM(s)). Currently, SA5 is still working on Rel-18 energy efficiency of 5G. On top of Rel-17, in Rel-18, SA5 is working on more accurate virtual CPU usage measurements from ETSI NFV MANO which could be used to estimate the Energy Consumption of virtual machines, new use cases for Energy Saving in the whole 3GPP system, considerations on digital sobriety, etc.

In the future releases, some of the parameters and measurement techniques/metrics may be further enhanced by SA2 WG to support the system level energy saving and the efficient operation.

SA5 also introduced the MDA (Management Data Analytics) assisted Energy Saving in clause 7.2.4 and clause 8.4.4 of TS 28.104. The MDA assisted energy saving is achieved by activating the energy saving mode of the NR capacity booster cell or 5GC NFs (e.g., UPF, etc.). With considering the energy saving policies setup by the operators, the Management Data Analytics Service (MDAS) producer is able to provide energy saving recommendations to the service consumer to assist with the energy saving decision-making. For example, the MDAS procedure may provide an output to indicate where the energy efficiency issues (e.g., high-energy consumption, low energy efficiency) exist in the system and the cause of the energy efficiency issues based on the request of the consumer.

Considering the energy cost is one of the most significant sources of operations costs for Mobile Network Operators (MNOs), there has been increasing work in 3GPP on improving energy efficiency (EE), energy saving(ES) and reducing the energy consumption (EC) of 5GS. In the above clauses, the existing work related to EE, ES, and EC in other 3GPP WGs is reviewed. From the network perspective, the previous solutions studied how to optimize energy consumption by adapting the network itself, e.g., activating and deactivating parts of the network including cells, network functions (NFs), etc. Such changes to the topology and components of the network could be either transparent to the network architecture or have implications with the architecture, e.g., reselection of proper network functions. The previous work is more from the perspective of network management, including the OAM and RAN node/cell management, or from the UE perspective. Previous work does not study how to improve and enhance the energy saving and energy efficiency from the system level, i.e., considering the end-to-end energy saving and energy efficiency of a service, or UE, etc. Before Rel-19, standardization work on Enhancement for Energy Efficiency and Energy Saving as Service Criteria for NR system has not been introduced to SA2.

As mentioned above, stage 1 requirements for energy as a service criteria have been identified by SA1 in the FS_EnergyServ study. Some of the SA1 requirements need to be addressed by SA2, i.e., by introducing new functionalities and mechanisms by SA2. The goal of the SA1 energy efficiency is to provide the same services in a more efficient manner, i.e., the services could be provided in an energy-aware manner, considering the energy use control as service criteria, and functional requirements could include the ability to control energy use based on operator policies such as ‘energy credit limits’ and ‘maximum energy usage rate’ applying to services provided to a UE or group of UEs.

Also, SA plenary has issued a 3GPP-wide recommendation on considering Energy Efficiency as an important design criterion for the technical solutions 3GPP defines in their specifications (see SP-211621). Therefore, SA2 decided to investigate options for improved system behavior aimed at energy saving and energy efficiency in Rel-19.

The SID of SA2 work has been approved in the plenary meeting in SP-231192 (September 2023), including:
WT #1. Study potential framework for network energy consumption exposure. This will include whether and what information is exposed, how it is exposed (e.g., charging) and at what granularity, e.g., at RAN level, Core Network level, network slice level, UE level, PDU session level, and/or QoS flow level. Additionally, whether and how renewable energy or carbon emission information for such granularities can be exposed by an MNO will be studied.
WT #2. Study enhancement for subscription and policy control to enable network energy savings as service criteria.
WT #3. Study 5GS enhancements (e.g., energy usage adjustment for NF from CN aspect, energy saving related decision making, NF selection leveraging NF energy states) for network energy saving including 5GC (NFs) and NG-RAN interactions, analytics, etc. Impacts on the UE are not ruled out e.g., for scenarios specified in TR 22.882 by SA1 EnergyServ.

In order to support the above objectives, SA2 study is being carried out between November 2023 to May 2024.

For WT #2, the Key Issue (KI) descriptions have been approved in S2-2313823 in SA2 160 meeting in November 2023 and documented in clause 5.2 of TR 23.700-66:

5.2 Key Issue #2: Subscription and policy control to support energy efficiency and energy saving as service criteria

5.2.1 Description

Energy related information as service criteria allows delivering services based on e.g., energy related subscriptions and policies to achieve the goal of energy saving.

The following aspects will be studied for this key issue:
Whether and how to enhance the existing subscription and policy control framework to support energy related information as service criteria, including:
Whether and what new energy related UE subscription information are to be defined, and whether and how to use the energy related UE subscription information.
Whether and what new energy related policies are to be defined, and how to perform energy related policy control, e.g. to determine, provision and enforce energy related policies.
At what granularity (e.g., network slice, UE, NF, PDU Session, QoS flow, application ID, etc.) the energy related policy control can be performed.
What network energy related information is required for subscription and policy control and how it is obtained.
Whether and how the above enhancements on subscription and policy control will impact charging.

NOTE 1: Charging enhancement aspects, if any, are to be addressed in coordination with SA WG5.

NOTE 2: The study will address use cases corresponding to the identified requirements as described in clause 6.15a.2 of TS 22.261 [8]. The possible enhancements on subscription and policy control depend on the use case. Solutions should identify related use cases which will be addressed.

NOTE 3: The potential impact of the enhancements will be evaluated to ensure not to consume more energy than expected to save.

The NR policy and charging framework is mainly documented in TS 23.503. The existing policy control could be divided into non-session management related policy control and session management related policy control.

The non-session management related policy control mainly includes: Access and mobility related policy control, UE policy control, Management of packet flow descriptions, SMF selection management related policy control, etc. The non-session management related network capability could be exposed to the AF from the NEF.

Session management related policy control is more referred to as PCC (Polices and Charging Control) rules. The basic requirements for the session management related policy control include (in clause 4.3.1 of TS 23.503), but are not limited to:
It shall be possible for the PCC framework to base decisions upon subscription information, Access Type and the RAT Type.
A PCC rule may be predefined or dynamically provisioned at establishment and during the lifetime of a PDU Session. The latter is referred to as a dynamic PCC rule.
It shall be possible to take a PCC rule into service, and out of service, at a specific time of day, without any PCC interaction at that point in time.
It shall be possible with the PCC framework, in real-time, to monitor the overall amount of resources that are consumed by a user and to control usage independently from charging mechanisms, the so-called usage monitoring control.
The PCC framework shall support making policy decisions based on subscriber spending limits.
The PCC framework shall support making policy decisions for N6 traffic steering.

The requirements of Session management related policy control include many different aspects, i.e., Gating control requirements, QoS control requirements at different levels (i.e., service data flow level, PDU session level, QoS flow level), Subscriber spending limits requirements (enforce policies based on subscriber spending limits based on information requested by PCF from CHarging Function, CHF), Usage monitoring control requirements (i.e., for PCF (Policy Control Function) to make/modify decisions of PCC rules), and Application detection and control requirements.

As mentioned in clause 4.3.6 of TS 23.503, Support for network capability exposure enables an AF (e.g., an external ASP) to request the following session management related policy control functionality from the NEF:
Set or change a chargeable party at AF session setup (see clause 4.15.6.4 and 4.15.6.5 of TS 23.502);
Set up an AF session with required QOS (see clause 6.1.3.22 and clause 4.15.6.6 of TS 23.502);
Request QoS, traffic characteristics provisioning and performance monitoring for an individual UE or a group of UEs (see clause 4.15.6.14 of TS 23.502);
Transfer of traffic characteristics of Time Sensitive Communication from the TSN AF (see clause 6.1.3.23) or from the TSCTSF (see clause 6.1.3.23a).
Set up a time synchronization service from the TSCTSF (see clauses 5.27.1.8 and 6.1.3.23a of TS 23.501 and clause 4.15.9 of TS 23.502).

Based on the previous SA1 work and the SA2 ongoing topic, enhancements to Subscription and policy control should be introduced to support energy efficiency and energy saving as service criteria in Rel-19. However, based on the above reviews of the legacy techniques, for now, in the specification, there are not session or non-session related management policies and subscriptions considering the energy related aspects, i.e., energy credit/limit, energy consumption, requirements of energy saving, and energy rate.

In order to support the requirements in clause 5.2 of TR 23.700-66, enchantments to Subscription and policy control considering energy related aspects are desirable.

According to an aspect of the present disclosure, there is provided a method of an Application Function, AF, acquiring energy information from an Energy Information Function, EIF, in a telecommunication network, comprising the steps of:
the AF issuing a subscription request to the EIF, via a Network Exposure Function, NEF;
the EIF responding, if authorized, with a confirmation; and
the EIF further providing to the AF, via the NEF, energy information.

In an embodiment, the NEF authorizes the subscription request from the AF.

In an embodiment, the energy information is energy consumption information.

In an embodiment, the energy information is provided or requested at one of: User Equipment, UE, level; Protocol Data Unit, PDU, session level; and Quality of Service, QoS, flow level.

In an embodiment, the AF further requests certain resources for a session.

In an embodiment, if the request for the certain resources is approved, the PCF informs a Session Management Function, SMF, of the request and the SMF manages an associated session accordingly.

In an embodiment, the request comprises an energy saving profile comprising at least one of a desired energy saving, consumption level, efficiency, communication service features that can be adjusted according to a required energy savings level and energy credit.

In an embodiment, the subscription request also relates to an unsubscription request. For example, the AF may transmit the unsubscription request to the EIF for unsubscription from the subscription related to the energy information.

According to an aspect of the present disclosure, there is provided an apparatus arranged to perform the above method of any preceding embodiment.

In the context of embodiments of the present application, references to charging or charges relate primarily to monetary charges for an end user. The end user may be rewarded (or disadvantaged) in some way for conserving (or extravagantly using) energy. The reward may take the form of monetary discounts or increased/improved services in a later charging period. A disincentive may take the form of a reduced user experience. In essence, a user's experience of the network may be affected by their energy usage, in positive or negative ways. For instance, a user who has used less energy than some form of defined target may be rewarded with an increased data allowance.

According to the present disclosure there is provided an apparatus and method as set forth in the appended claims. Other features of this disclosure will be apparent from the dependent claims, and the description which follows.

Although a few preferred embodiments of the present disclosure have been shown and described, it will be appreciated by those skilled in the art that various changes and modifications might be made without departing from the scope of this disclosure, as defined in the appended claims.

Before undertaking the detailed description below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

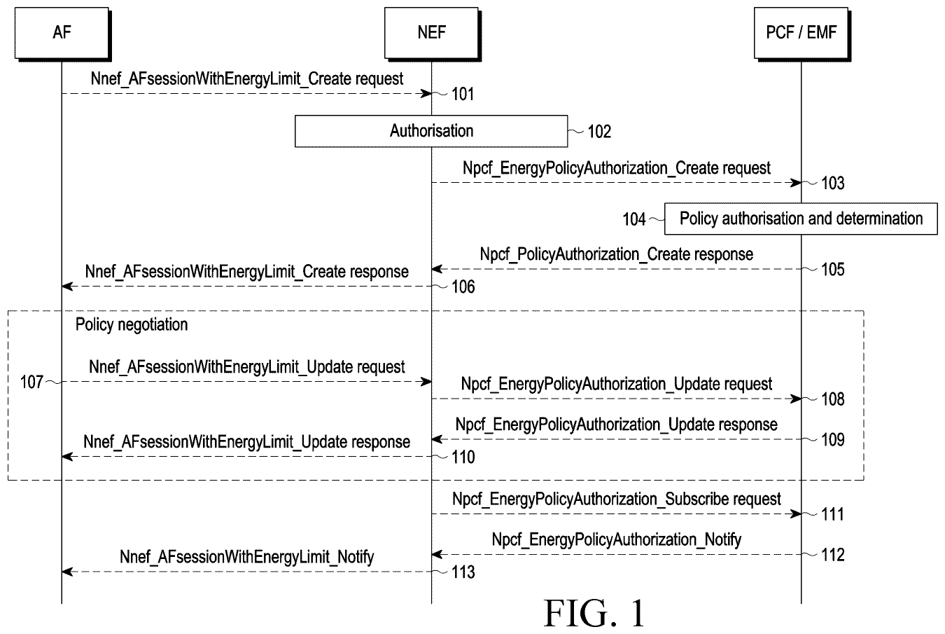

FIGS. 1 through 4B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of this disclosure aim to address the issues in KI#2 by enhancing the session management related policy control with included energy related aspects. As required by SA1 in clause 6.15a.2.2 of TS 22.261, the 5GC shall define and enforce subscription and policies considering energy related aspects for services, e.g., by considering the maximum allowed energy consumption.

Considering the significant cost on energy for 5GS operation, subject to operator policies, 3rd party service providers (referred to below as 3rd parties) and network operators may setup energy related limits or requirements for a service operation to limit the energy expense. For example, the AF and 5GC may apply the maximum energy consumption allowance/energy credit or minimum energy efficiency for delivering a service via 5GS to one or more users. In order to enforce the energy related requirements within 5GS, e.g., energy credit of a service, the AF and 5GC may apply different service operation quality requirements (e.g., different QoS) to different available energy consumption credits. Considering the above issues, the policy control with energy constraints should be agreed between the 3rd party and 5GC before the service starts. The agreed policy between the 3rd party and 5GC can be used to monitor and manage the session(s) during the service operation to ensure that the 5GS provides the service in the required energy efficient way, e.g., by implementing the energy credit. During the service operation, the 5GS operation status might be varied by different reasons. As a result, the 5GS may not be able to satisfy the agreed energy related policy. In this case, the 5GC may take actions to enforce the energy policy (e.g., by modifying the AM or SM policies), or interact with the 3rd party to notify the new policies.

In order to generate and enforce the policies with energy related requirements (e.g., energy credit or energy efficiency requirement) within 5GS and provide services in the energy-efficient way that can satisfy the demands of the 3rd party and network operators, interactions between the AF and 5GC are needed. Before the services starts, the AF may send the energy requirements and limits to the 5GC and require the 5GC to generate and authorize the policy for service operation. The AF may also optionally indicate some other service requirements along with the energy requirements, e.g., a list of QoS parameters, potential service time windows, etc. Upon receiving the AF request, the 5GC (e.g., the PCF) will determine the energy related policy control.

The policy decision will be made by considering multiple items of information, including the information in the AF request and the relevant information the PCF collects within 5GS. For example, the PCF can collect the prediction and statistics of energy consumption and efficiency from NWDAF and collect other energy related data from different data sources, e.g., OAM and the energy monitoring, management network function (EMF), if any, etc. The PCF will use the collected data to verify whether the energy requirements or limits in the AF request are implementable by 5GS or not. The 5GC may also consider the service quality requirements along with the energy information, if indicated by the AF. The determined policy will be notified by the PCF to the AF.

The energy monitoring, management network function (EMF) can be a standalone network function or co-located with other network functions (e.g., PCF, NWDAF, etc.). Note that the EMF may be known by one or more different terms and is not yet finalized in the relevant standards documents. One possible title is Energy Information Function (EIF). This may be implemented as a standalone NF or form a part of another NF such as PCF or NWDAF.

Alternatively, the PCF may send a request to the monitoring, management network function (EMF) to collected data to verify whether the energy requirements or limits in the AF request are implementable by 5GS or not. Then the EMF sends the results back to the PCF. The EMF may also send PCF the possible QoS or the service quality can be provided, associated to different energy requirements or limits.

The energy related measurement data (i.e., energy consumption of a PDU session, a QoS flow, UE(s), etc.) can be collected from OAM or energy monitoring, management network function (EMF), if any. The 5GC will also consider the service quality requirements along with the energy information, if indicated by the AF. The determined policy will be notified by the PCF to the AF.

However, considering the 5GS performance and working principle, the energy related requirements in the AF request could be inapplicable for 5GS. In this case, the 5GS may not grant the AF request or may negotiate with the AF by providing alternative policies including the energy requirements or limits. For example, if the PCF verifies that energy consumption credit provided by the AF is not able to complete the required service, the PCF may not grant the AF request and notify AF about the result. Then the AF may send a new request to the 5GC. Or the 5GC may provide one or more alternative policies including applicable energy related requirements or limits/constraints and optionally the corresponding feasible service quality to the AF for negotiation. The AF will notify PCF the final decision on the energy policy for the service operation.

During the service operation, in order to enforce the agreed energy related policy, the PCF may request or subscribe to data and notifications that are relevant to energy from multiple data sources, e.g., the PCF may subscribe to EMF (if any) to receive an energy usage status related notification. Based on the reporting and notifications, the PCF will take actions to ensure that the agreed energy related policy can be satisfied. For example, the PCF can require energy consumption and energy efficiency related notification from OAM, or the appropriate 5GC NFs (i.e., SMF, EMF, if any). If the energy consumption (e.g., of one or more PDU sessions, QoS flows, UEs) reaches a certain level, the PCF may lower the service quality requirements, e.g., by increasing the packet error rate to reduce retransmission and therefore to reduce the energy consumption, reducing the traffic volume for XR services, etc. Or if the PCF is notified that the energy consumption credit is used up, the PCF may determine to revoke the resources allocated to the service and terminate the service, or deactivate/suspend the session for a while until new energy consumption credit is available for service transmission.

During the service operation, the PCF or AF may trigger policy modification in different scenarios, e.g., the energy consumption credit is changed from the AF side or the 5GS performance variation, the 5GC is not able to provide the service by enforcing in the agreed energy policy, etc. In this case, the PCF can generate new policies, subject to operator's policy and based on data collected within 5GS and AF as described above. Then the PCF will inform the AF of the new policy. Further negotiation between the 5GC and AF on the acceptable policies is also possible.

This solution provides an approach for the AF and 5GC to determine, modify, and enforce the policy control considering energy constraints/requirements and limits. The AF and 5GC may negotiate the service operation strategies (e.g., QoS parameters) considering the required energy efficiency and allowed energy consumption credit. The 5GC can take actions to enforce the policy to limit the energy consumption or enhance the energy efficiency of a service. In this way, services can be provided to the subscribers in an energy efficient manner that satisfies the requirements of both the 3rd party and MNO.

In embodiments of this disclosure:
Energy includes any type of energy, i.e., renewable energy and non-renewable energy (including coal, oil and gas), if there is no other explicit explanation.
Renewable energy includes any types of sources that can be constantly replenished, i.e., sunlight, wind, etc.
Different granularities/levels include at RAN level, Core Network level, network slice level, UE level, PDU session level, and/or QoS flow level, if there is no other explicit explanation.

The policy control framework of energy saving and energy efficiency is as required by SA1 in clause 6.15a.2.1 in TS 22.261:
“For best-effort traffic, that is, without QoS criteria, policies can be defined to limit energy use for services. This is not in conflict with the principle that performance policies will not be traded off for energy efficiency, since best-effort service has no performance guarantees.
Specifically, best-effort traffic can be subject to a policy that limits the maximum energy consumption over time, or further constrained by location (so that the energy consumption limit only applies when used in a specified service area.)
Additionally, policies can be defined with a maximum energy credit limit, e.g. for best-effort services to limit the total amount of energy consumption according to an energy charging rate. These policies expand the options of subscription policies to control energy consumption in the 5G system.”

In an embodiment, the Policy control framework of energy saving and energy efficiency is fully specified with introducing energy related aspects as the limits/constraint for a session/service, etc. In the current specifications, there are no policy control mechanisms, and subscription information considers energy related aspects as part of the requirements/thresholds/constraints/conditions. For example, in the current session management related policy control frameworks, the AF session may consider charging related issues, QoS requirements, or request QoS, traffic characteristics provisioning, and performance monitoring for UE(s), etc., are specified. Therefore, the 5GS transfers and manages the traffic in a more efficient manner, i.e., the 5GC may interact and negotiate with AF regarding the policy of transferring the service, generating the policy for resource utilization monitoring, etc.

The procedures, as performed by the PCF can be replaced by any other 5GC NF, e.g., an energy monitoring, management related network function (EMF).

FIG. 1 illustrates the message exchanges in an embodiment involved in setting up an AF session with energy-related limits/requirements. The messages in this figure are labelled 1-13 and are described in detail below:

1. The AF sends a request to 5GC to request the policy control considering energy aspects for an AF session of one or multiples UEs using the Nnef_AFsession WithEnergyLimit_Create request message (101). The AF may invoke the NEF service operation by using the Nnef_AFsession WithEnergyLimit_Create request message. The request message to the NEF may include energy related requirements or allowance of a service. For example, the maximum energy consumption credit, the required energy efficiency of service operation, different energy consumption thresholds associated to different operation strategies, etc. Optionally, the AF may also indicate the requirements of the service quality corresponding energy requirements, for example, the minimum QoS requirements of the service associated to the required energy efficiency or the maximum energy consumption credit. The UE address(es), AF Identifier, DNN, S-NSSAI may also included in the request message.

The AF sends a request to 5GC NF to indicate energy related limits/requirements for an AF session for one or multiples UEs using Nnef_AFsession WithEnergyLimit_Create request message to the NEF. Nnef_AFsession WithEnergyLimit_Create request may include: energy related requirements/limits and general information:
Energy related requirements/limits may include:
Energy related requirements/limits may be for a maximum credit of energy consumption/energy usage/energy efficiency, etc.;
Energy related requirements/limits may be for a UE, group of UEs, a service (including multiple UEs);
Energy related requirements/limits might be at granularities/levels, i.e., at RAN level, Core Network level, network slice level, UE level, PDU session level, and/or QoS flow level.
The Energy related requirements/limits might be for a period of time, i.e., energy consumption during a period of time, i.e., an hour, a day, a month, etc.;
Energy related requirements/limits might be of an area, i.e., energy consumption or energy efficiency of a cell, a list of cell(s)/TA(s)/beams/RAN notification area, energy efficiency area, etc.
General information may include: address of a specific UE or multiple UEs to indicate the UEs to be involved into the service/AF session with energy related requirements/limits, AF Identifier to identify the AF, S-NSSAI (i.e., if the energy related limits/constraints are for slice granularity), DNN, etc. The AF may indicate the QoS requirements, QoS parameters, alternative QoS requirement of the service with energy limit/requirement to 5GC (i.e., PCF or the energy monitoring and management related NF, via NEF if the AF is not trusted), if any.

2. The NEF authorizes the AF request that contains Energy related requirements/limits and may apply policies to control the overall amount of energy consumption/energy usage authorized for the AF (102).
If the authorization is not granted, all steps (except step 5) are skipped and the NEF replies to the AF with a Result value indicating that the authorization failed.
The NEF may provide alternative recommended Energy related requirements/limits to the AF for further use/negotiation.

3. The NEF uses the UE address(es) indicated in step 1 to discover the PCF(s) from the BSF. Then the NEF forwards the parameters received in step 1 to the PCF by invoking PCF service operation, e.g., Npcf_/Nemf_EnergyPolicyAuthorization_Create request message (103). Or the NEF discovers the energy monitoring, management related network function (EMF).

If the AF is considered to be trusted by the operator, the AF uses the Npcf_/Nemf_EnergyPolicyAuthorization_Create message to interact directly with PCF/EMF to indicate and negotiate the energy related limits for an AF session, without via the NEF.

4. The PCF/EMF determines whether to authorize the request from the NEF in step 3 (104). In order to determine whether the request could be authorized or not, the PCF may collect energy information from multiple data sources, e.g., NWDAF, OAM, SMF, energy monitoring, management network function (EMF), if any, etc. For example, the PCF may trigger the NWDAF to provide the prediction and statistics of energy consumption or energy efficiency at different granularities, the PCF may collect energy related measurements from EMF, OAM or other 5GC NF to understand the energy consumption over a period of time, etc. Based on the collected information, the PCF is able to verify whether the AF request can be satisfied by the 5GS or not.

If the PCF/EMF determines that the AF request is not able to be satisfied by the 5GS, the 5GC may reject the AF request and notify the outcome to the AF.

The PCF may determine to negotiate with AF regarding the policy, i.e., by providing alternative policies including the energy related requirements or limit that can be provided by 5GS to the AF. For example, the PCF may generate different implementable energy consumption allowance and energy efficiency along with different service operation strategies.

For requests received from the NEF in step 3, the PCF/EMF determines whether the request is authorized and notifies the NEF if the request is not authorized (104).
If the request is authorized, the PCF/EMF derives/collects energy related information based on the information provided by the NEF in step 3 or directly provided by the AF. The PCF will determine and check whether the energy related limits/requirements can be satisfied/achieved by the 5GS or not. The PCF/EMF will generate the policies related to energy control and will notify the result to the NEF.

If the AF is considered to be trusted by the operator, the PCF/EMF will notify the results to the AF directly, via Npcf_/Nemf_EnergyPolicyAuthorization_Create response message.
The PCF may determine and authorize the energy related requirements/policy control based on the parameters provided by NEF/AF, and also the multiple data collected/requested/subscribed to from other 5GC NFs, OAM, RAN node, UEs, etc.
In order to collect/request data from other entities and subscribe to other entities for notification of the data of interests, the PCF/EMF may trigger some procedures towards other 5GC NFs, OAM, RAN node, UEs to collect/monitor/derive information related to energy, i.e., PCF triggers NWDAF to derive and notify PCF/EMF of the prediction and statistics of energy consumption/energy efficiency/energy requirements based on parameters indicated by the PCF, or the PCF may collect energy related information from the energy monitoring/management NF, PCF triggers QoS monitoring or other measurements towards SMF, UPF, etc.
The procedures/events triggered by the PCF/EMF to collected data related (directly or indirectly) to energy information can be considered as part of the energy related policy control.
The energy control related policies might include multiple parameters/requirements, i.e., generated by the PCF/EMF. The policies may include: the maximum allowed (overall) energy credit (i.e., for a service, a UE, multiple UEs, one or multiple RAN node, Core Network, network slice, UE, PDU session level, and/or QoS flow level, etc.). Optionally, the PCF may also notify the QoS parameters/requirements/5QI of the service/service flow/QoS flow/AF session along with the energy related requirements.
If more than one service requirements/parameters are provided, i.e., more than maximum energy credit, maximum energy consumption allowance, maximum/minimum energy efficiency, maximum/minimum energy rate, energy states of 5GC/NF/RAN node/UE/PDU session/QoS flow are provided, the PCF/EMF may derive the possibility/probability/likelihood/priority of the energy related requirements/limits.
Optionally, the PCF/EMF provide the service requirements/parameters could be provided by 5GC (i.e., QoS parameters/requirements/5QI, latency, data rate/throughput, etc.) along with the corresponding energy related limits/requirements. Therefore, the AF/NEF would understand the service quality can be provided by 5GS of the corresponding energy related aspects (i.e., energy consumption, energy efficiency, require maximum energy credit).
The PCF/NEF/AF/EMF may prioritize the service

requirements/parameters with higher possibility/probability/likelihood/priority to provide the service to the users, considering the policy requirements, (service/operator) configuration.

The PCF/NEF/AF/EMF may prioritize the requirements/parameters with the lowest energy consumption, highest efficiency, etc. as higher priority, i.e., considering the energy cost/price.
The PCF/EMF may also generate energy related rules/policies to trigger procedures/events toward other 5GC NF/RAN/UE, etc., i.e., resource monitoring, parameters, etc.
The PCF/EMF may determine to update the energy related policy, i.e., based on the request from AF/NEF, based on monitoring results reported to PCF/event notification from other 5GC NF/RAN/UE/OAM, etc., i.e., the PCF may determine to update the energy related policy based on notification/request from the energy monitoring and management related NF, SMF, UPF when energy related events are triggered. The energy related events could be triggered based on energy consumption, energy usage reach a threshold/limit, based on efficiency (i.e., the efficiency is lower or higher than a threshold/limit).
The PCF/EMF may update/modify the determined policy and inform the policy to the consumers, i.e., other 5GC NF/RAN/UE/NEF, the 5GC may also notify the new policy to AF (via NEF).
Based on the event triggered/notification/the monitoring results, the PCF may also determine to revoke the policy and resources/configuration allocated corresponding to this policy, or determine to terminate/revoke the service and notify the AF, NEF, 5GC NFs (i.e., SMF, UPF, etc.), RAN, UE, etc.
The PCF/EMF may notify the update/modification/revoke/delete of the policies to AF, NEF, 5GC NFs (i.e., SMF, UPF, etc.) by invoking the corresponding pcf_update/modification/revoke/delete service operations.

5. The PCF/EMF notifies the NEF about whether the request in step 3 authorized or not by sending Npcf_/Nemf_PolicyAuthorization_Create response message (105). As mentioned in step 4, the PCF may also include the alternative policies including the energy related requirements or limit that can be provided by 5GS to the AF for energy policy negotiation.

The NEF sends a Nnef_AFsession WithEnergyLimit_Create response (Transaction Reference ID, Result) to the AF (106). Result indicates whether the request is granted or not.
The NEF may also include the accepted/proposed/determined energy related information/parameters in the response message, i.e., the maximum energy credit/energy consumption/energy usage allowance/energy efficiency at one or more different granularities/levels of a UE or multiple UEs/of a service, etc.
Upon receiving the response message, the AF acknowledges that whether the request towards 5GC with energy related requirements is accepted or not, and the accepted energy related requirements by 5GC, and the priority/likelihood/probability of the accepted energy related requirements (if more than one accepted energy related requirements are indicated).

6. The NEF sends a Nnef_AFsession WithEnergyLimit_Create response (Transaction Reference ID, Result, optionally alternative policy) to the AF to indicate the authorization outcome (106).

7. Conditionally, if the PCF/EMF determines to negotiate with AF and sends more than one alternative policies to the AF in step 5 and 6, to align the understanding between AF and 5GC about the policy to be applied, the AF needs to choose and inform the 5GC about the acceptable policy by invoking Nnef_AFsession WithEnergyLimit_Update request (107).

8.-10. Conditionally, the NEF forwards the selected policy from AF to PCF/EMF (108). The PCF/EMF acknowledges NEF (109). NEF responds to the AF request about the policy acceptance by PCF/EMF (110).

11.-13. After the agreement of energy related policy is successfully established between AF and 5GC, the NEF may subscribe to events or notifications of energy usage or energy efficiency of PDU session, QoS flow, UE(s), etc., and other events (e.g., QoS monitoring, data volume during a period of time, session activation and inactivation time, etc.) during the service operation (111). When the condition is met, i.e., when the energy consumption reaches a certain level, or the energy efficiency is lower than a threshold, the PCF/EMF may notify the NEF about the events and the values of the energy related parameters (112). The NEF sends notify message with the events and parameters reported by the PCF/EMF to the AF (113).

After the session/resources/agreements are successfully made between AF and 5GC/5GC NF/PCF/energy monitoring and management related NF, the NEF may subscribe to events/notifications of energy related policy modification/updates, energy related monitoring results/alters/warning, resource allocation status based on energy usage/energy consumption/energy efficiency, the energy status of 5GC/5GC NF/RAN/UE, etc. (if available), etc.

When the event condition related to energy is met by the PCF/EMF, e.g., that the energy consumption is higher than a threshold, the energy efficiency is lower than a threshold, the maximum energy credit is used up/met, the data volume/throughput is higher than a threshold, the 5GC cannot provide the service with required energy limits/parameters, etc., the PCF/EMF sends Npcf_/Nemf_EnergyPolicyAuthorization_Notify message to the NEF notifying about the energy related events.

If the AF is considered to be trusted by the operator, the PCF/EMF sends the Npcf_/Nemf_EnergyPolicyAuthorization_Notify message directly to AF.

The NEF sends Nnef_AFsession WithEnergyLimit_Notify message with the event reported by the PCF to the AF in step 7.

The AF may send request to NEF in order to revoke the AF request with energy related requirements. The NEF authorizes the revoke request and triggers the PCF/EMF service to PCF/EMF to revoke/delete the AF request, i.e., Npcf_/Nemf_EnergyPolicyAuthorizationEnergy_Delete service operations for the AF request.

If the AF is trusted by the operator, the AF directly sends the request to the PCF/EMF to revoke/delete the previous AF request.

The PCF/EMF or AF can modify or update the previously agreed energy related policy in different scenarios, i.e., energy consumption credit is changed from the AF side, since the 5GC might not be able to provide the service in the agreed manner considering the energy limits, or the operator's policy changed, etc. The PCF can generate new policies subject to operator's policy and based on data collected within 5GS (i.e., from NWDAF, energy monitoring and management NF, OAM, RAN node, etc.) and AF requirements, if any. Then the PCF/EMF will inform the AF of the new policy. Further negotiation between the 5GC and AF on the acceptable policies is also possible.

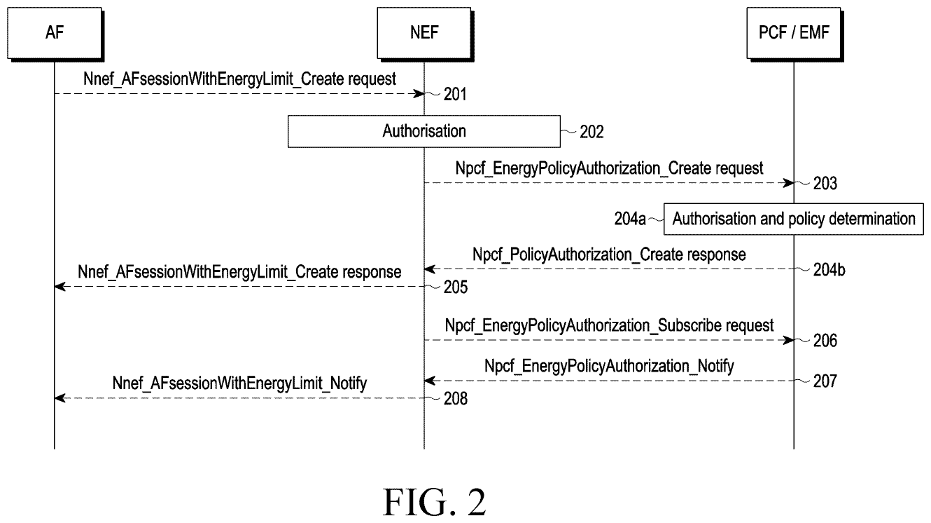

FIG. 2 illustrates the message exchanges in an embodiment involved in setting up an AF session with energy-related limits/requirements. The messages in this figure are labelled 1-8 and are described in detail below:

1. The AF sends a request to 5GC NF to indicate energy related limits/requirements for an AF session for one or multiples UEs using Nnef_AFsession WithEnergyLimit_Create request message to the NEF. (201) Nnef_AFsession WithEnergyLimit_Create request may include: energy related requirements/limits and general information:
Energy related requirements/limits may include:
Energy related requirements/limits may be for a maximum credit of energy consumption/energy usage/energy efficiency, etc.;
Energy related requirements/limits may be for a UE, group of UEs, a service (including multiple UEs);
Energy related requirements/limits might be at granularities/levels, i.e., at RAN level, Core Network level, network slice level, UE level, PDU session level, and/or QoS flow level.
The Energy related requirements/limits might be for a period of time, i.e., energy consumption during a period of time, i.e., an hour, a day, a month, etc.;
Energy related requirements/limits might be of an area, i.e. energy consumption or energy efficiency of a cell, a list of cell(s)/TA(s)/beams/RAN notification area, energy efficiency area, etc.
General information may include: address of a specific UE or multiple UEs to indicate the UEs to be involved into the service/AF session with energy related requirements/limits, AF Identifier to identify the AF, S-NSSAI (i.e., if the energy related limits/constraints are for slice granularity), DNN, etc. The AF may indicate the QoS requirements, QoS parameters, alternative QoS requirement of the service with energy limit/requirement to 5GC (i.e., PCF or the energy monitoring and management related NF, via NEF if the AF not trusted), if any.

2. The NEF authorizes the AF request that contains Energy related requirements/limits and may apply policies to control the overall amount of energy consumption/energy usage authorized for the AF (202).

If the authorization is not granted, all steps (except step 5) are skipped and the NEF replies to the AF with a Result value indicating that the authorization failed.
The NEF may provide alternative recommended Energy related requirements/limits to the AF for further use/negotiation.

3. The NEF uses the UE address(es) indicated in step 1 to discover the PCF(s) from the BSF. The NEF forwards received parameters indicated in step 1 to the PCF in the Npcf_/Nemf_EnergyPolicyAuthorization_Create request message (203). Or the NEF discovers the energy monitoring, management related network function (EMF).

If the AF is considered to be trusted by the operator, the AF uses the Npcf_/Nemf_EnergyPolicyAuthorization_Create message to interact directly with PCF/EMF to indicate and negotiate the energy related limits for an AF session, without via the NEF.

4. For requests received from the NEF in step 3, the PCF/EMF determines whether the request is authorized and notifies the NEF if the request is not authorized (204a).
If the request is authorized, the PCF/EMF derives/collects energy related information based on the information provided by the NEF in step 3 or directly provided by the AF. The PCF/EMF will determine and check whether the energy related limits/requirements can be satisfied/achieved by the 5GS or not. The PCF/EMF will generate the policies related to energy control and will notify the result to the NEF.
If the AF is considered to be trusted by the operator, the PCF/EMF will notify the results to the AF directly, via Npcf_/Nemf_EnergyPolicyAuthorization_Create response message (204b).
The PCF/EMF may determine and authorize the energy related requirements/policy control based on the parameters provided by NEF/AF, and also the multiple data collected/requested/subscribed to from other 5GC NFs, OAM, RAN node, UEs, etc.
In order to collect/request data from other entities and subscribe to other entities for notification of the data of interests, the PCF/EMF may trigger some procedures towards other 5GC NFs, OAM, RAN node, UEs to collect/monitor/derive information related to energy. i.e., PCF/EMF triggers NWDAF to derive and notify PCF/EMF of the prediction and statistics of energy consumption/energy efficiency/energy requirements based on parameters indicated by the PCF/EMF, or the PCF/EMF may collect energy related information from the energy monitoring/management NF, PCF triggers QoS monitoring or other measurements towards SMF, UPF, etc.
The procedures/events triggered by the PCF/EMF to collected data related (directly or indirectly) to energy information can be considered as part of the energy related policy control.

The energy control related policies might include multiple parameters/requirements, i.e., generated by the PCF/EMF. The policies may include: the maximum allowed (overall) energy credit (i.e., for a service, a UE, multiple UEs, one or multiple RAN node, Core Network, network slice, UE, PDU session level, and/or QoS flow level, etc.). Optionally, the PCF may also notify the QoS parameters/requirements/5QI of the service/service flow/QoS flow/AF session along with the energy related requirements.
If more than one service requirements/parameters are provided, i.e., more than maximum energy credit, maximum energy consumption allowance, maximum/minimum energy efficiency, maximum/minimum energy rate, energy states of 5GC/NF/RAN node/UE/PDU session/QoS flow are provided, the PCF may derive the possibility/probability/likelihood/priority of the energy related requirements/limits.

Optionally, the PCF/EMF provide the service requirements/parameters could be provided by 5GC (i.e., QOS parameters/requirements/5QI, latency, data rate/throughput, etc.) along with the corresponding energy related limits/requirements. Therefore, the AF/NEF would understand the service quality can be provided by 5GS of the corresponding energy related aspects (i.e., energy consumption, energy efficiency, require maximum energy credit).
The PCF/NEF/AF/EMF may prioritize the service requirements/parameters with higher possibility/probability/likelihood/priority to provide the service to the users, considering the policy requirements, (service/operator) configuration.
The PCF/NEF/AF/EMF may prioritize the requirements/parameters with the lowest energy consumption, highest efficiency, etc. as higher priority, i.e., considering the energy cost price.
The PCF/EMF may also generate energy related rules/policies to trigger procedures/events toward other 5GC NF/RAN/UE, etc., i.e., resource monitoring, parameters, etc.
The PCF/EMF may determine to update the energy related policy, i.e., based on the request from AF/NEF, based on monitoring results reported to PCF/event notification from other 5GC NF/RAN/UE/OAM, etc., i.e., the PCF may determine to update the energy related policy based on notification/request from the energy monitoring and management related NF, SMF, UPF when energy related events are triggered. The energy related events could be triggered based on energy consumption, energy usage reach a threshold/limit, based on efficiency (i.e., the efficiency is lower or higher than a threshold/limit).
The PCF/EMF may update/modify the determined policy and inform the policy to the consumers, i.e., other 5GC NF/RAN/UE/NEF, the 5GC may also notify the new policy to AF (via NEF).
Based on the event triggered/notification/the monitoring results, the PCF/EMF may also determine to revoke the policy and resources/configuration allocated corresponding to this policy, or determine to terminate/revoke the service and notify the AF, NEF, 5GC NFs (i.e., SMF, UPF, etc.), RAN, UE, etc.
The PCF/EMF may notify the update/modification/revoke/delete of the policies to AF, NEF, 5GC NFs (i.e., SMF, UPF, etc.) by invoking the corresponding pcf_update/modification/revoke/delete service operations.

5. The NEF sends a Nnef_AFsession WithEnergyLimit_Create response (Transaction Reference ID, Result) to the AF. Result indicates whether the request is granted or not (205).
The NEF may also include the accepted/proposed/determined energy related information/parameters in the response message, i.e., the maximum energy credit/energy consumption/energy usage allowance/energy efficiency at one or more different granularities/of a UE or multiple UEs/of a service, etc.
Upon receiving the response message, the AF acknowledges that whether the request towards 5GC with energy related requirements is accepted or not, and the accepted energy related requirements by 5GC, and the priority/likelihood/probability of the accepted energy related requirements (if more than one accepted energy related requirements are indicated).

6. After the session/resources/agreements are successfully made between AF and 5GC/5GC NF/PCF/energy monitoring and management related NF, the NEF may subscribe to events/notifications of energy related policy modification/updates, energy related monitoring results/alters/warning, resource allocation status based on energy usage/energy consumption/energy efficiency, the energy status of 5GC/5GC NF/RAN/UE (if available), etc. (206).

7. When the event condition related to energy is met by the PCF/EMF, e.g., that the energy consumption is higher than a threshold, the energy efficiency is lower than a threshold, the maximum energy credit is used up/met, the data volume/throughput is higher than a threshold, the 5GC cannot provide the service with required energy limits/parameters, etc., the PCF/EMF sends Npcf_/Nemf_EnergyPolicyAuthorization_Notify message to the NEF notifying about the energy related events (207).

If the AF is considered to be trusted by the operator, the PCF/EMF sends the Npcf_/Nemf_EnergyPolicyAuthorization_Notify message directly to AF.

8. The NEF sends Nnef_AFsession WithEnergyLimit_Notify message with the event reported by the PCF to the AF in step 7 (208).

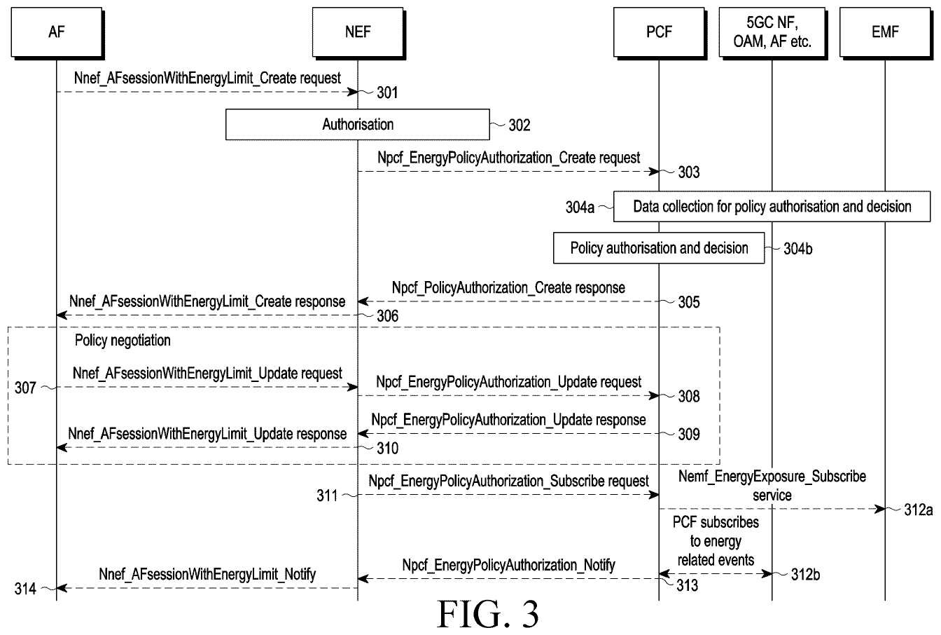

FIG. 3 illustrates the message exchanges in an embodiment involved in setting up an AF session with energy-related limits/requirements. The messages in this figure are labelled 1-14 and are described in detail below:

1. The AF sends a request to 5GC to request the policy control considering energy aspects for an AF session of one or multiples UEs. The AF may invoke the NEF service operation by using the Nnef_AFsession WithEnergyLimit_Create request message (301).

The request message to the NEF may include energy related requirements or allowance of a service, e.g., the maximum energy consumption credit, the required energy efficiency of service operation, different energy consumption thresholds associated to different operation strategies (e.g., QoS), etc. The UE address(es), AF Identifier, DNN, S-NSSAI may also included in the request message.

Optionally, the AF may also indicate the requirements of the service quality corresponding energy requirements, for example, the minimum QOS requirements of the service associated to the required energy efficiency or the maximum energy consumption credit.

2. The NEF authorizes the AF request that contains energy related requirements for the AF session (302). If the authorization is not granted by NEF, the following steps (except for step 6) will be skipped and the NEF indicates to the AF about the authorization failure.

3. The NEF uses the UE address(es) indicated in step 1 to discover the PCF(s) from the BSF. Then the NEF forwards the parameters received in step 1 to the PCF to authorize and generated energy related policy, e.g., by invoking PCF service operation Npcf_EnergyPolicyAuthorization_Create request message (303).

If the AF is considered to be trusted by the operator, the AF invokes the PCF service operation (e.g., Npcf_EnergyPolicyAuthorization_Create) directly to the PCF to indicate and negotiate the energy related requirement or limits for the AF session.

4. The PCF determines whether to authorize the request from the NEF in step 3 (304a/304b).

4a. In order to determine whether the request could be authorized or not, the PCF may collect energy information from multiple data sources, e.g., NWDAF, OAM, SMF, EMF, if any, etc. (304a). For example, the PCF may trigger the NWDAF to provide the prediction and statistics of energy consumption or energy efficiency at different granularities, the PCF may collect energy related measurements from EMF, OAM or other 5GC NF, etc.

4b. PCF determines whether to authorize the AF request or not and determine energy policy (304b). Based on the collected information, the PCF is able to evaluate whether the request from AF can be satisfied by the 5GS or not.

If the PCF determines that the AF request is not able to be satisfied by the 5GS, the 5GC may reject the AF request and notify the outcome to the AF.

The PCF may determine to negotiate with AF regarding the policy, i.e., by providing alternative policies including the energy related requirements or limit that can be provided by 5GS to the AF. For example, the PCF may generate different implementable energy consumption allowance/credit and energy efficiency, optionally associated with different service operation strategies.

5. The PCF notifies the NEF about whether the request in step 3 is authorized or not by sending Npcf_PolicyAuthorization_Create response message (305). As mentioned in step 4, the PCF may also include the alternative policies including the energy related requirements or limit that can be provided by 5GS to the AF for energy policy negotiation.

6. The NEF sends a Nnef_AFsession WithEnergyLimit_Create response (Transaction Reference ID, Result, optionally alternative policy) to the AF to indicate the authorization outcome (306).

7. [CONDITIONAL] if the PCF determines to negotiate with AF and sends more than one alternative policies to the AF in step 5 and 6, to align the understanding between AF and 5GC about the energy policy to be applied, the AF needs to choose and inform the 5GC about the accepted policy by invoking Nnef_AFsession WithEnergyLimit_Update request (307).

8.-10. [CONDITIONAL] the NEF forwards the selected policy from AF to PCF (308). The PCF acknowledges NEF (309). NEF responds to the AF request about the policy acceptance by PCF (310).

11. After the agreement of energy related policy is successfully established between AF and 5GC, the NEF may subscribe to events or notifications of energy usage or energy efficiency of PDU session, QoS flow, UE(s), etc., and other events (e.g., QoS monitoring, data volume during a period of time, session activation and inactivation time, etc.) during the service operation (311).

12. The PCF may subscribe to different data sources for the energy related information exposure or notification to assist PCF with energy related policy update.

12a. PCF may subscribe to EMF (if any) for the energy related information exposure or notification, for example for the energy usage status related notification, e.g., energy usage reaches a threshold or the energy credit is used up, or energy efficiency is lower than a threshold, etc. (312a).

12b. The PCF may subscribe to NWDAF for the energy related analytics, to OAM for energy related measurements at NF/slice/gNB level, to SMF for the data rate and traffic volume, etc. (312b).

13. When the condition is met, the PCF notifies the NEF about the events and optional the values of the energy related parameters (313).

14. The NEF sends notify message with the events and parameters reported by the PCF to the AF (314).

The PCF or AF can modify or update the previously agreed energy related policy in different scenarios since the 5GC might not be able to provide the service in the agreed manner considering the energy limits or operator's policy, i.e., in the scenarios that energy consumption credit is changed from the AF side or 5GS performance degradation, etc. The PCF can generate new policies or update existing policies subject to operator's policy and based on data collected within 5GS (i.e., from NWDAF, energy monitoring and management NF, OAM, RAN node, etc.) and AF. Then the PCF will inform the AF of the new policy. Further negotiation between the 5GC and AF on the acceptable policies is also possible.

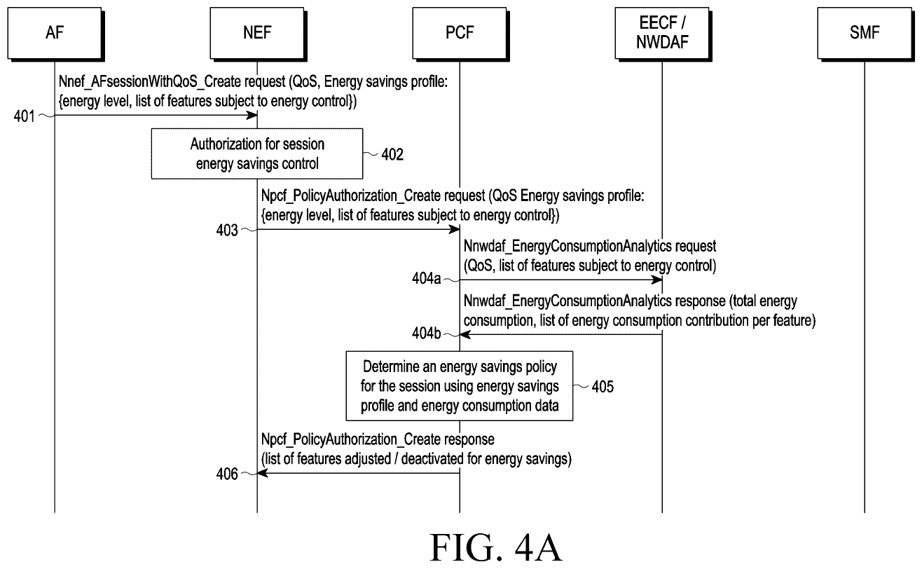

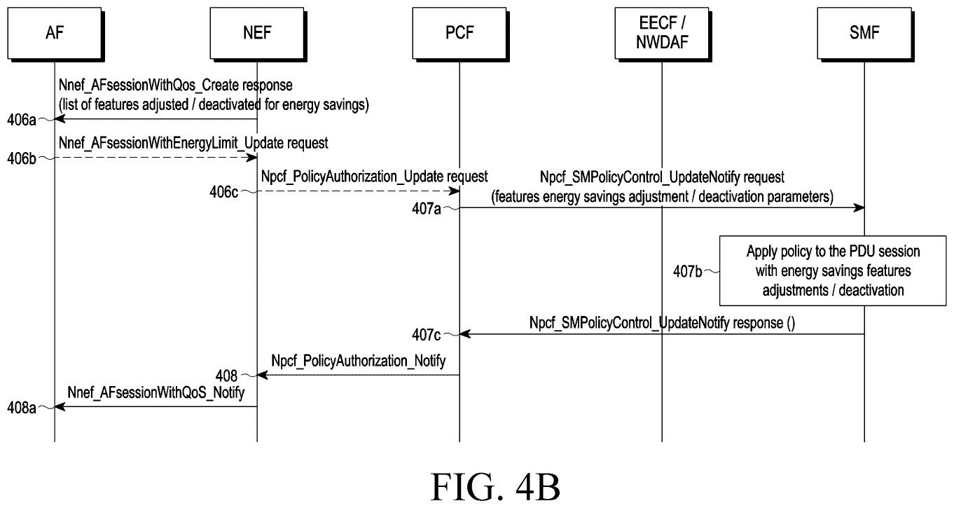

FIGS. 4A and 4B illustrate message exchanges in an embodiment involving setting up an AF session with required Energy savings procedure. The messages in these figures are labelled 1-14 and are described in detail below:
1. The AF sends a request to reserve resources for an AF session with energy savings criteria using Nnef_AFsessionWithQoS_Create request message including QoS parameters and energy saving profile information which may include energy savings level, the energy credit, required energy efficiency and optionally features subject to energy savings control/adjustment (401).
2. The NEF checks authorization for the AF request and may apply policies to verify that that feature based energy savings control can be authorized for the AF and the features allowed to be under energy related requirement, e.g., savings control, the energy credit, required energy efficiency (402). If the authorization is not granted, the NEF rejects the request and otherwise proceeds with the following steps.
3. The NEF forwards received parameters to the PCF in the Npcf_PolicyAuthorization_Create request (403).
4. The PCF sends to the NWDAF or EECF a request to retrieve energy consumption analytics by providing Application Identifier, QOS parameters and the list of features subject to energy control/adjustment (e.g., which can be adjusted or enabled/disabled for the communication service) (404a).

The PCF receives the energy consumption data from the NWDAF/EECF including per feature relative contribution to the energy consumption associated with the service/session (404b).
5. The PCF determines a policy configuration for the PDU Session (i.e., PCC rules, etc.) using the energy consumption data and requested session energy related profile to achieve the desired energy requirements in the AF request (e.g., the energy saving level, the energy credit, required energy efficiency) (405). The PCF determines the features for which PCC rules and other policy configuration information that needs to be established or updated for the adjustment/disablement of the features accordingly.
6. The PCF sends Npcf_PolicyAuthorization_Create response informing the NEF/AF whether the request is granted and includes information on the adjusted or de/activated features and energy policy and requirements for the session (406). If the NEF/AF request cannot be granted by the PCF (e.g., due to the available energy credit or required energy efficiency cannot be met), the PCF may determine to negotiate with AF on the application energy related criteria.
6.-6a. [Conditional] if the PCF determines to negotiate with AF, the PCF may include one or more alternative energy related criteria, optionally along with the policies, to the AF (via NEF) (406a).

6b.-6c. [Conditional] the AF may choose the acceptable energy related criterion and inform the PCF of the decision (via NEF) (406b/406c). If the AF cannot choose any acceptable energy related criterion provided by the PCF, based on its internal logic, the AF will also inform the PCF of this outcome.

7. The PCF updates the SMF with the corresponding policy indicating rules for the features adjustment or de/activation for energy related requirements, e.g., energy savings, energy credit, required energy efficiency, etc. (407a) The SMF applies the policy with energy savings rules to the PDU Session (407b) and notifies the PCF of success or failure (407c).

8. The PCF notifies the NEF/AF when the establishment of the transmission resources with corresponding energy requirements succeeded or failed (408/408a).

In this embodiment, considering the 5GS performance might be varied due to different reasons, the energy related criteria or requirements in the AF request or the authorized energy related criteria might be not applicable. In this case, the 5GS may determine to negotiate with the AF by providing alternative policies and energy criteria. For example, if the PCF verifies that energy credit provided by the AF is not able to complete the required service at the desired level, the PCF may indicate the alternative energy credit(s) and the associated assistance information (e.g., QoS, data volume, etc.) to the AF (via NEF) for negotiation. The AF will notify PCF the final decision on the energy policy for the service operation.

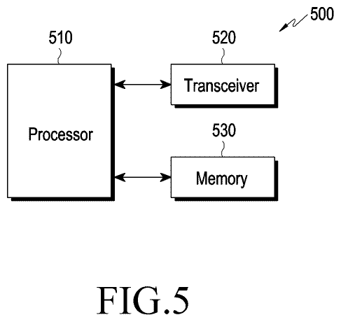

FIG. 5 illustrates a block diagram of an apparatus for a network entity according to an embodiment of the present disclosure.

The network entity may be one of the network functions described herein. For example, the network entity may be one of the AF, the NEF, the PCF, the EMF (or EIF), the NWDAF and the SMF.

The network entity may be implemented through the apparatus (500). The apparatus may comprise at least one processor (510), a transceiver (520) and a memory (530).

The at least one processor (510) may be operably coupled to other components (e.g. the transceiver (520) and the memory (530) of the apparatus (500). The at least one processor may control operations of the other components of the apparatus (500) and overall operations of the apparatus (500). The at least one processor (510) may perform or may cause the apparatus (500) to perform the operation based on executing instructions stored in the memory.

The transceiver (520) may support communication of the apparatus (500) or the at least one processor (510). The apparatus (500) may communicate with other entity using the transceiver (520). The transceiver (520) may support various known communication schemes (e.g. code divisional multiple access (CDMA), long term evolution (LTE), orthogonal frequency division multiplexing (OFDM), Wi-Fi, Wi-MAX, Bluetooth, . . . etc).

The memory (530) may stores data for operations of the apparatus. The data may comprise temporary data or permanent data. The memory (530) may store the instructions. When the instructions are executed by the at least one processor (510), the apparatus (500) may perform operations of the network entity described herein. The memory (530) may be referred to as a non-transitory computer readable storage medium.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

This disclosure is not restricted to the details of the foregoing embodiment(s). This disclosure extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an Application Function (AF) for obtaining energy information from an Energy Information Function (EIF) in a communication network, the method comprising:
transmitting a subscription request related to the energy information to the EIF, via a Network Exposure Function (NEF);
receiving a response for the subscription request from the EIF; and
receiving the energy information from the EIF based on the subscription request being authorized by the EIF.

2. The method of claim 1, wherein in case that the subscription request is authorized by the NEF, the subscription request is delivered by the NEF to the EIF.

3. The method of claim 1, wherein the energy information includes energy consumption information.

4. The method of claim 1, wherein the energy information is at at least one of: a User Equipment (UE) level, a Protocol Data Unit (PDU) session level, and a Quality of Service (QoS) flow level.

5. The method of claim 1, further comprising:
transmitting a request for resources for a session related to energy saving to the NEF.

6. The method of claim 5, wherein if the request for the resources is approved by the PCF, the PCF informs a Session Management Function (SMF) of the request for managing the session.

7. The method of claim 6, wherein the request comprises an energy saving profile including at least one of a desired energy saving, a consumption level, efficiency, and communication service features that can be adjusted according to a required energy savings level and energy credit.

8. The method of claim 1, further comprising transmitting an unsubscription request related to the energy information to the IEF.

9. An apparatus for an Application Function (AF) for obtaining energy information from an Energy Information Function (EIF) in a communication network, the apparatus comprising:
a transceiver; and
at least one processor coupled to the transceiver, wherein the at least one processor is configured to:
transmit a subscription request related to the energy information to the EIF, via a Network Exposure Function (NEF);
receive a response for the subscription request from the EIF; and
receive the energy information from the EIF based on the subscription request being authorized by the EIF.

10. The apparatus of claim 9, wherein in case that the subscription request is authorized by the NEF, the subscription request is delivered by the NEF to the EIF.

11. The apparatus of claim 9, wherein the energy information includes energy consumption information.

12. The apparatus of claim 9, wherein the energy information is at at least one of: a User Equipment (UE) level, a Protocol Data Unit (PDU) session level, and a Quality of Service (QoS) flow level.

13. The apparatus of claim 9, wherein the at least one processor is further configured to:
transmit a request for resources for a session related to energy saving to the NEF.

14. The apparatus of claim 13, wherein if the request for the resources is approved by the PCF, the PCF informs a Session Management Function (SMF) of the request for managing the session.

15. The apparatus of claim 14, wherein the request comprises an energy saving profile including at least one of a desired energy saving, a consumption level, efficiency, and communication service features that can be adjusted according to a required energy savings level and energy credit.

16. The apparatus of claim 9, wherein the at least one processor is further configured to transmit an unsubscription request related to the energy information to the IEF.

17. A method performed by an Energy Information Function (EIF) for providing energy information in a communication network, the method comprising:
receiving g a subscription request related to the energy information from an Application Function (AF), via a Network Exposure Function (NEF);
transmitting a response for the subscription request to the AF; and
transmitting the energy information to the AF based on authorizing the subscription request.

18. The method of claim 17, wherein in case that the subscription request is authorized by the NEF, the subscription request is delivered by the NEF to the EIF.

19. The method of claim 17, wherein the energy information includes energy consumption information.

20. The method of claim 17, wherein the energy information is at at least one of: a User Equipment (UE) level, a Protocol Data Unit (PDU) session level, and a Quality of Service (QoS) flow level.
